(19) United States
(12) Patent Application Publication
(10) Pub. No.: US 2004/0049924 A1
(43) Pub. Date: Mar. 18, 2004

(54) Methods and apparatus for cutting and chopping food

(76) Inventors: Scott Robinowitz, Tulsa, OK (US); Stacey Robinowitz, Tulsa, OK (US); Frederick Mitchell, Lauderdale Lakes, FL (US)

Correspondence Address: Mark P. Stone, 1100 High Ridge Road, Stamford, CT, 06905, US

(21) Appl. No.: 10/246,651

(22) Filed: Sep. 18, 2002

(51) Int. Cl. B26B 3/00

(52) U.S. Cl. 30/307; 30/299; 30/304; 30/306

(57) ABSTRACT

A food chopper and cutter has at least two rotary cutting elements which are mounted on a common shaft and are rotatable relative to a common handle. Movement of the cutting elements conforms to the contours of the inner surface of a salad bowl to quickly and efficiently cut salad. The cutting elements are also movable in a substantially perpendicular direction relative to the plane of the inner surface of the salad bowl to provide a chopping action in addition to the rotatable cutting action.

### BACKGROUND OF THE INVENTION

The present invention is directed to food choppers and food cutters, and in particular vegetable choppers for preparing salads.

Known food choppers of the aforementioned type are exemplified by the following patents and published patent applications: U.S. Pat. Nos. 5,979,281; 5,913,484; 5,632,450; 4,572,444; 4,346,634; 4,247,984; 4,192,470; 4,019,689; 3,933,315; D437,748; D437,749; D390,745; D378,182; D346,090; D339,716; D331,170; D330,664; D260,351; and published Application No. 20020020067.

The known prior art food cutting devices exhibit certain notable disadvantages. Many of the devices are formed from complex mechanical structures requiring complicated manual maneuvers to operate. More importantly, the known devices do not effectively and efficiently chop and cut food, and in particular vegetables in a salad bowl, because the known devices do not efficiently interact with the sloped, curved and contoured inner surfaces of a typical salad bowl.

It is the primary objective of the present invention to provide methods and apparatus for efficiently chopping and cutting foods, particularly vegetables in a salad bowl, using a relatively simple and cost efficient device to permit chopping and cutting both on flat cutting surfaces and on curved and contoured surfaces such as the inner side walls of a typical salad bowl. The chopping and cutting procedure in accordance with the present invention processes food in an efficient manner and in significantly less time with significantly less physical exertion by the operator, than is possible with the known food chopping and food cutting devices.

Other objects and advantages of the present inventiion will become apparent from the following discussion thereof in conjunction with the drawings.

### SUMMARY OF THE INVENTION

A food chopping and cutting device, and in particular a salad cutter and chopper, includes at least a pair of rotatable cutting elements mounted on a common shaft. Each cutting element is formed from a rotatable disk, the periphery thereof defining a cutting edge. The shaft carrying the rotatable cutting elements is mechanically linked to a handle for enabling an operator to manipulate the device.

In the preferred embodiment of the invention, both cutting elements are axially aligned at their respective centers along the common shaft on which they are mounted and laterally spaced a predetermined distance apart from each other along the shaft, and each cutting element is independently rotatable relative to the other cutting element.

In further embodiments of the invention, the separate cutting elements may be oriented relative to each other such that they are longitudinally offset from each other and not in axial alignment. In this embodiment, the common supporting shaft for the rotatable cutting elements will be bent.

Although in the preferred embodiment of the invention each of the cutting elements is independently rotatable relative to the other on the supporting shaft, it is within the scope of the present invention to mount each cutting element on the supporting shaft such that the cutting elements conjointly rotate together with the supporting shaft.

It is also within the scope of the present invention to provide a plurality of supporting shafts, each of which carries one or more rotatable cutting elements spaced apart from each other.

Means are provided for removing, at the selection of the user, one or more of the rotatable cutting elements for maintenance, repair, or replacement, as may be required.

The device of the present invention provides a tool for cutting and chopping food which includes at least two rotatable cutting blades spaced apart a predetermined lateral distance from each other, and mechanically coupled to a handle. As a result of the rotatable nature of the cutting blades, food, and in particular vegetables, can be cut and chopped by rolling movement of the cutting elements both on the bottom surface of a salad bowl, and along the curved and contoured inner side walls of the salad bowl. The linkage of the rotatable cutting elements to the handle of the device provides the user with a mechanical advantage which, in cooperation with the rotatable nature of the cutting elements, requires less exertion of energy by the operator and permits the cutting/chopping operation to be completed in significantly less time than would be required by the known chopping devices. The device of the present invention also permits the user, if necssary, to chop and cut food by raising the device above the food and lowering it onto the food instead of, or in addition to, chopping or cutting the food exclusively by rolling the rotatable cutting elements over the food to be processed.

In the preferred embodiment of the invention, the mechanical linkage between the rotatable cutting elements and the handle is provided by a fork-like structure with separate prongs engaging the supporting shaft for the rotatable cutting elements at a location proximate to each cutting element. Preferably, the fork and each of the rotatable cutting elements are formed from food grade stainless steel. Although the preferred embodiment of the invention employs at least two rotatable cutting elements, it is within the scope of the invention to provide the food cutting/chopping device with more than two rotatable cutting elements.

### BRIEF DESCRIPTION OF THE DRAWINGS

FIG. 1 is a right side elevational view of the food cutter and chopper device in accordance with the preferred embodiment of the present invention; and

FIG. 2 is a top plan view of the food cutter and chopper device illustrated by FIG. 1.

### DISCUSSION OF THE BEST MODES FOR CARRYING OUT THE INVENTION

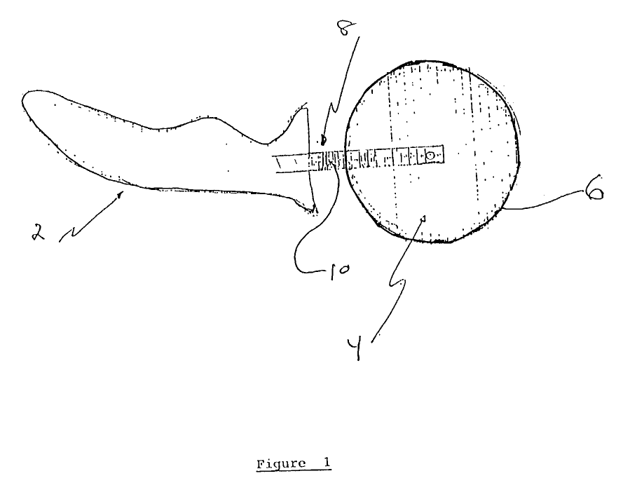

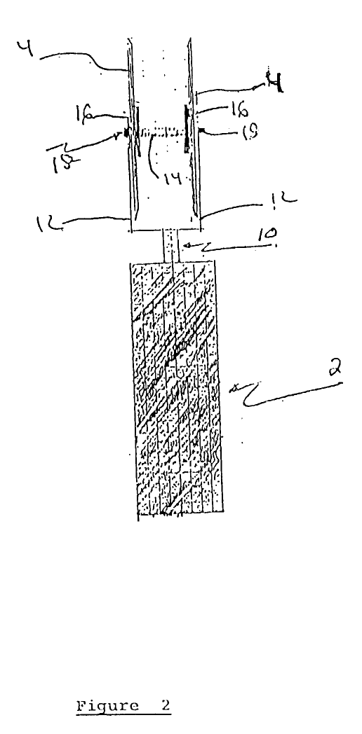

FIGS. 1 and 2 illustrate the food cutter and chopper device in accordance with the present invention.

The device includes an ergonomic handle designated by reference numeral 2, mechanically coupled by a coupling structure generally designated by reference numeral 8, to at least a pair of rotatable disk shaped cutting elements 4. Each cutting element 4 is beveled and defines a peripheral cutting edge designated by reference numeral 6.

As best illustrated by FIG. 2, the mechanical coupling structure 8 is a fork shaped element formed from a base 10 and two forwardly extending arms 12. Each arm 12 is mechanically coupled through a fastener element 18 to a different one of the cutting elements 4.

Each of the two cutting elements 4 is, at its center, rotatably mounted to a common shaft generally designated by reference numeral 14. Shaft 14 extends between the two cutting elements 4, and is oriented substantially perpendicularly to the two cutting elements. Support washers 16 are provided to prevent lateral movement of the cutting elements 4 along the shaft 14 to assure that the cutting elements 4 are laterally spaced a predetermined distance apart from each other along the shaft. In the preferred embodiment of the invention as best illustrated by FIG. 2, the pair of cutting elements 4 are maintained in axial alignment with each other when mounted on the shaft 14.

Preferably, the shaft 14 is fixedly mounted to the opposed arms 12 such that the shaft 14 is stationary relative to the cutting elements 4 which are rotatably mounted thereon. In this manner, the two cutting elements 4 are independently rotatable relative to each other. However, it is also within the scope of the present invention to rotatably mount the shaft 14 to the supporting arms 12, and fixedly mount each cutting element 4 on the shaft 14 so that the two cutting elements 4 are conjointly rotatable with the shaft 14.

Preferably, the cutting elements 4 and the mechanical coupling structure 8 are both formed from food grade stainless steel. The fastener elements 18, which mount the cutting elements 4 to the shaft 14, permit the cutting elements 4 to be removed from the device at the selection of the user, for maintenance, repair and replacement purposes as may be necessary. Preferably, the two cutting elements 4 are maintained at a lateral spacing of approximately one inch apart from each other.

In operation, the user of the device grasps the handle 2 and rolls the rotatable cutting elements 4 over the food to be cut. The device is particularly useful in connection with cutting and chopping vegetables in a conventional wooden salad bowl having a substantially flat bottom surface and contoured or curved rising sidewalls. The rotatable cutting elements readily conform to the curved contour of the sidewalls of the salad bowl and are capable of riding along the sidewalls, in both vertical and horizontal directions, to chop and cut food against both the sidewalls and the flat bottom surface of the bowl. The rotatable nature of the cutting elements 4 permits the user to continuously cut food in the bowl as the device is continuously rolled over the different sections of the bowl, both in a forward and backward direction. Preferably the cutting is done in a grid format in which the device is rolled in a plurality of parallel paths along the entire inner surface of the bowl (both the flat bottom portion and the contoured sidewalls), and then is moved along a different plurality of parallel paths which are substantially perpendicular to the first plurality of paths. In addition to chopping and cutting food by the continuous rolling operation of the rotatable cutting elements, the device can, at the selection of the user, be raised above the food in the bowl, and lowered onto the food in the bowl to chop the food without the rolling movement of the device along the inner surface of the bowl. Thus, the user may process food in the bowl by both a continuous rolling movement of the device, and a downward chopping movement of the device, as desired.

Although the preferred embodiment of the invention discloses two rotatable cutting elements mounted in axial alignment to a common shaft 14, it is within the scope of the present invention to include more than two rotatable cutting elements mounted to the common shaft. For example, one or more additional cutting elements can be mounted to the shaft 14 between the two cutting elements 4 illustrated by FIG. 2. The one or more additional cutting elements 4 preferably will be mounted in axial alignment with each of the two cutting elements 4 illustrated by FIG. 2, and additional supporting washers will be provided to prevent lateral movement of the additional cutting elements along the shaft 14 and to maintain all cutting elements spaced predetermined lateral distances apart from each other.

Although the preferred embodiment of the food cutting and chopping device in accordance with the present invention includes a plurality of cutting elements axially aligned and laterally spaced a predetermined distance apart from each other, it is also within the scope of the invention to orient the cutting elements 4 out of axial alignment with each other. This can be accomplished, for example, by bending the common shaft 14 to provide a segment thereof perpendicularly oriented to its lateral axis of extension, and thereafter bending the shaft perpendicularly back into its original lateral axis so as to longitudinally offset the center of one cutting element 4 relative to the center of the other cutting element 4.

It is also within the scope of the present invention to provide more than a single shaft 14 extending between the opposed supporting arms 12. For example, a second shaft, oriented parallel to the shaft 14 shown in FIG. 2, can be provided to extend between the opposed supporting arms 12 at a position between the arms 12 which is longitudinally offset from the shaft 14 shown in FIG. 2. At least one cutting element 4 is mountable to each of the shafts so that the device includes at least two separate cutting elements 4. The separate cutting elements 4 on the separate shafts are preferably oriented to be laterally offset from each other.

As discussed herein, the preferred embodiment of the invention is directed to a food cutting and chopping device having at least two rotatable disk shaped cutting elements which are in axial alignment with each other and laterally spaced a predetermined distance apart. However, the scope of the invention is not intended to be limited to the preferred embodiment of the invention, and encompasses the modifications to the preferred embodiment discussed herein.

Although the preferred embodiment of the invention includes a separate mechanical coupling element for connecting the handle with the rotatable cutting elements, it is within the scope of the invention to form the coupling structure as an integral part of the handle, and not a separate coupling element as illustrated by the preferred embodiment of the invention.

Although the preferred embodiment of the invention includes a common shaft 14 extending laterally between two opposed supporting arms 12 for mounting the cutting elements 4 to the shaft, it is within the scope of the present invention to eliminate the common shaft 14 and to rotatably mount one cutting element directly to each of the opposed supporting arms 12. The cutting elements can be mounted to the opposed supporting arms such that the cutting elements are in axial alignment with each other. In the alternative, the cutting elements can be mounted to the opposed supporting arms such that the cutting elements are longitudinally offset from each other.

Other modifications and variations within the scope of the invention will become apparent to those skilled in the art. Accordingly, the embodiments of the food cutters and choppers disclosed herein are intended to be illustrative only, and not restrictive of the scope of the invention, that scope being defined by the following claims and all equivalents thereto.

1. A food cutter and chopper comprising:
at least a pair of rotatable cutting elements, and
a handle coupled to said rotatable cutting elements.

2. The food cutter and chopper as claimed in claim 1, further including a coupling element disposed between said handle and said rotatable cutting elements for coupling said handle to said rotatable cutting elements.

3. The food cutter and chopper as claimed in claim 2, further including a shaft extending between said cutting elements, said cutting elements being mounted to said shaft.

4. The food cutter and chopper as claimed in claim 3, wherein said coupling element includes at least two arms extending between said handle and said cutting elements, one of said arms being coupled to a first end of said shaft, the other of said arms being coupled to a second end of said shaft.

5. The food cutter and chopper as claimed in claim 4, wherein said shaft is oriented substantially perpendicular to said arms.

6. The food cutter and chopper as claimed in claim 3, wherein said cutting elements are mounted to said shaft in axial alignment with each other.

7. The food cutter and chopper as claimed in claim 6, wherein said cutting elements are laterally spaced a predetermined distance apart from each other on said shaft.

8. The food cutter and chopper as claimed in claim 3, wherein each of said cutting elements is disk shaped.

9. The food cutter and chopper as claimed in claim 8, wherein each of said cutting elements defines a cutting edge on the periphery thereof.

10. The food cutter and chopper as claimed in claim 3, wherein said cutting elements are mounted to said shaft such that said cutting elements are independently rotatable relative to each other.

11. The food cutter and chopper as claimed in claim 3, wherein said cutting elements are mounted to said shaft such that said cutting elements are conjointly rotatable together.

12. The food cutter and chopper as claimed in claim 3, further including means for removing said cutting elements from said shaft.

13. The food cutter and chopper as claimed in claim 3, wherein two said cutting elements are mounted to said shaft.

14. A food cutter and chopper comprising:
at least a pair of rotatable cutting elements,
a handle coupled to said rotatable cutting elements, and
a shaft extending between said cutting elements, said cutting elements being mounted to said shaft.

15. The food cutter and chopper as claimed in claim 14, wherein said shaft is oriented substantially perpendicular to said cutting elements.

16. The food cutter and chopper as claimed in claim 14, wherein said cutting elements are mounted to said shaft in axial alignment with each other, said cutting element being spaced a predetermined distance from each other on said shaft.

17. The food cutter and chopper as claimed in claim 16, wherein said cutting elements are mounted to said shaft such that said cutting elements are independently rotatable relative to each other.

18. The food cutter and chopper as claimed in claim 16, wherein said cutting elements are mounted to said shaft such that said cutting elements are conjointly rotatable together.

19. A method of cutting food, the steps of said method comprising:
placing food to be cut on a cutting surface; and
rolling a food cutter, comprising a handle coupled to at least a pair of rotatable cutting elements, over said food on said cutting surface.

20. The method as claimed in claim 19 further including the step of raising said food cutter above said food on said cutting surface, and lowering said food cutter such that said cutting elements engage said food on said cutting surface.
